(19) United States
(12) Patent Application Publication
(10) Pub. No.: US 2005/0125396 A1
(43) Pub. Date: Jun. 9, 2005

(54) Electronic apparatus and file search method thereof

(76) Inventor: Li-Sen Liu, Pingihen City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/003,985

(22) Filed: Dec. 3, 2004

(30) Foreign Application Priority Data
Dec. 5, 2003 (TW) 92134474
Aug. 12, 2004 (TW) 93124212

(51) Int. Cl. G06F 7/00

(52) U.S. Cl. 707/3

(57) ABSTRACT

An electronic apparatus and a file search method thereof are provided. The file search method sequentially searches for a plurality of configuration files according to a file order table. The file search method searches for a next adjacent configuration file according to a starting point based on the location of a previously found configuration file in the file system. Thus, the sanity check on the configuration files is speeded up. As a result, the boot-up time for the electronic apparatus, particularly portable electronic apparatus, is shortened.

This application claims the benefit of Taiwan applications, Serial No. 92134474, filed Dec. 5, 2003, and Taiwan application Serial No. 93124212, filed Aug. 12, 2004, the subject matters of which are incorporated herein by reference.

### BACKGROUND OF THE INVENTION

1. Field of the Invention

The invention relates in general to an electronic apparatus and a file search method thereof, and more particularly to a portable electronic apparatus and a quick search method for searching for the configuration files of the portable electronic apparatus.

2. Description of the Related Art

With the success in scaling down the core operation chips and components, most of the portable electronic devices, such as mobile stations, PDAs (Personal Data Assistants), digital cameras and MP3 players (MPEG-3 players), are able to provide diversified functions to satisfy user's growing demands. By hardware designs and programmable functions or operation systems for executing various application programs according to the user's demands in the portable electronic devices, the diversified functions are realized.

To satisfy the user's demands, these various functions have to be set by the user himself so that the portable electronic device can work according to his preferred way. Hence, regardless of the settings in the hardware or application software, the portable electronic device must have various necessary hardware configuration files and user configuration files to set up the portable electronic device to execute various functions.

In general, the portable electronic device, such as the mobile phone, always performs a sanity check on the configuration files after the device is turned on in order to keep the device in normal operations according to the user's settings. The configuration files include the constantly existing files such as a hardware profile and a user profile. After the sanity check is completed, the mobile phone thus has normal reliable configuration files. The operation system of the mobile phone starts to adopt these configuration files to set up the hardware and to enable the application program for executing various software/hardware functions.

While executing the above-mentioned sanity check, the system must firstly find out the configuration files, and then do the sanity-check upon the configuration files. In other words, if the mobile phone has N configuration files, the system must execute N times of file searching operations. In the conventional file search method, each configuration file is searched initially from the root of the file system. Accordingly, the search complexity of the conventional method is O(N²).

However, since the mobile phone has many functions and might have over 100 configuration files, searching the configuration files one by one by executing the above-mentioned sanity check procedure would be extremely time-consuming. Hence, the user has to wait for a long time after the device is turned on, and thus has poor evaluation on the mobile phone.

Furthermore, in order to satisfy the file compatibility, most of the present mobile phones adopt the FAT (File Allocation Table) file system, which is widely used in the computer field. When the mobile phone is executing the above-mentioned sanity check, due to the slow conventional file search method in the FAT file system, the sanity check inevitably wastes a lot of time.

In terms of the trend of the diversified functions of the present portable electronic device, the number of the configuration files increases along with the increase of the functions and application programs in the portable electronic device. However, due to the consuming time that the sanity check requires, after the device is turned on, the user only can use the portable electronic device after a longer time is elapsed. Meanwhile, the user may feel inconvenient and have poor evaluation on the portable electronic device.

Consequently, the designer of the portable electronic device has to provide a solution to solve the above-mentioned problems and speed up the sanity check to shorten the waiting time after the user has turned on the portable electronic device.

### SUMMARY OF THE INVENTION

It is therefore an object of the invention to provide an electronic apparatus and a file search method thereof to speed up a sanity check operation for checking configuration files and to shorten the waiting time after a user turns on the electronic apparatus, particularly a portable electronic apparatus. The search method sequentially searches for these files according to a file order table. The search method searches for a next adjacent file according to a starting point based on the location of a found file in the file system during the previous search.

According to the object of the invention, a file search method of an electronic apparatus is provided, for searching for N configuration files stored in the electronic apparatus, wherein the configuration files is in a file system of the electronic apparatus and N is a positive number. The file search method includes the following steps: (a) providing an X being initially 0 and a location Y being initially at the root of the file system, X being an integer; (b) searching for an X-th configuration file starting from the location Y, and proceeding to step (c) if the X-th configuration file is found; (c) performing a sanity check on the X-th configuration file and setting the location Y to a location of the X-th configuration file; (d) incrementing X; and (e) determining whether X equals N; if so, ending the method; if not, proceeding to said step (b). In addition, the N configuration files respectively correspond to N filenames, and the N filenames respectively are recorded in N fields of a file order table.

According to another object of the invention, an electronic apparatus includes a memory device and a processor. The memory device stores a sanity check module and N configuration files, where N is a positive integer. The processor, coupled to the memory device, is for executing the sanity check module so as to perform sanity check on the N configuration files. The sanity check module performs the steps of: (a) providing X being initially 0 and a location Y being at the root of the file system, X being an integer; (b) searching for an X-th configuration file starting from the location Y, and proceeding to step (c) if the X-th configuration file is found; (c) performing a sanity check on the X-th configuration file and setting the location Y to a location of the X-th configuration file; (d) incrementing X; and (e) determining whether X equals N; if so, ending the sanity check; if not, proceeding to said step (b). In addition, the N configuration files respectively correspond to N filenames, and the N filenames respectively are recorded in N fields of a file order table.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a flow chart showing a file search method of an electronic apparatus according to a preferred embodiment of the invention.

FIG. 2 shows a mobile phone according to the preferred embodiment of the invention.

### DETAILED DESCRIPTION OF THE INVENTION

The invention proposes a search method for searching for constantly existing files in an electronic device. This file search method may be used for sanity-checking the configuration files after the electronic device is turned on in order to boot the electronic device in a short period of time. When the user needs to use this electronic device, the electronic device can immediately response. In addition, reducing the sanity check time is also helpful to the reduction of the power consumption.

According to the invention, the relative locality property of a plurality of constantly existing files (e.g., configuration files) on the storage locations and the location of a previous configuration file in the file system as a reference location for searching a next configuration file. For example, the system utilizes the location of the previously found configuration file as the starting point for searching for the next configuration file so as to increase the search speed.

The file search method of the invention will be described with reference to an embodiment. In this embodiment, it will be described how the search method of the invention sanity-checks the configuration files after the electronic device is turned on and allows the electronic device boot up in a short period of time. The electronic device may be a portable electronic device, such as a mobile station (e.g., mobile phone), a PDA (Personal Data Assistant), a MP3 player, a digital camera, or the like.

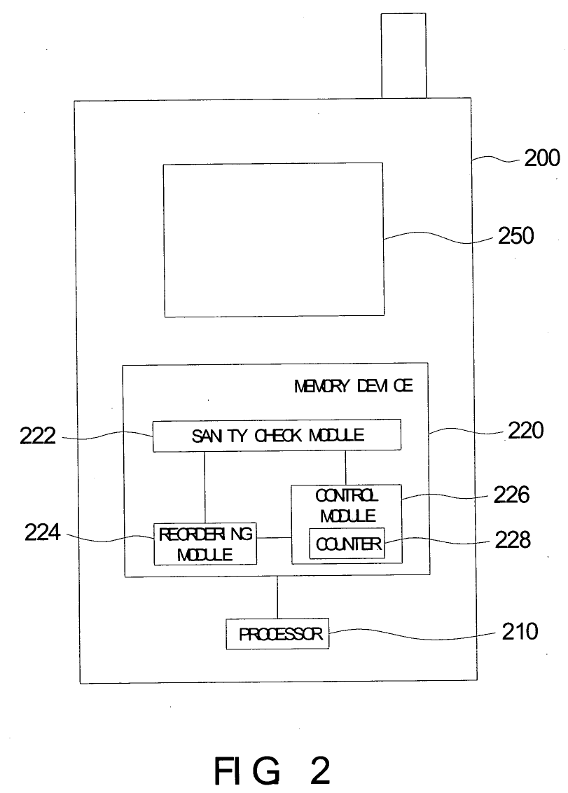

Before this embodiment is described, please refer first to the portable electronic device of FIG. 2. The portable electronic device is a mobile phone 200 having a file system for storing an operation system, an application program and a plurality of configuration files. The mobile phone 200 has a processor 210 and a memory device 220 coupled to the processor 210. The mobile phone 200 may have a color display 250, a wireless network communication function and a polyphony ringtone function, or even the digital camera function and the MP3 player function. Thus, the mobile phone 200 has many configuration files, which correspond to the profiles (e.g., user profiles) for the above-mentioned functions, the profiles (e.g., hardware profiles) of the internal hardware components of the mobile phone 200, and the like. In general, the hardware profiles represent the profiles associated with the display, the battery, the power management, the keyboard, and the like. The user profiles represent the profiles used by the application programs. In addition, the configuration file may further include the other files for storing a predefined value of identification code of the mobile phone 200. These configuration files have the relative locality property on the storage locations. That is, these configuration files are stored in the file system of the mobile phone 200.

When the mobile phone 200 is manufactured, the mobile phone manufacturer provides configuration files and stores them in the mobile phone 200 for the mobile phone 200 to work properly. These configuration files are generated according to a file order table. In other words, the order in which the configuration files are generated and the storage locations of the configuration files both depend on the arrangement of the configuration files in the file order table. In addition, the mobile phone manufacturer stores the file order table in the memory device 220 of the mobile phone 200. For example, the configuration file corresponding to the filename in the first field of the file order table is firstly generated and stored in a specific first location. Next, the configuration file corresponding to the filename in the second field is generated and stored in a second location. In general, the first location is adjacent to the second location, or a predetermined location relationship exists between the first location and the second location. Consequently, the storage locations of two configuration files generated sequentially will have a predetermined location correlation, for example being adjacent to each other.

As mentioned above, the mobile phone 200 sanity-checks all the configuration files after it is turned on, the operation system of the mobile phone must find and then sanity-check the configuration files one by one. In other words, after the mobile phone is turned on, the processor executes the operation system and loads a sanity check module 222 from the memory device 220 to sanity-check these configuration files and thus complete the booting operation. The sanity check module 222 finds and sanity-checks the configuration files according to the file order table. After the sanity check is completed, the operation system of the mobile phone 200 starts to utilize these configuration files to set up the hardware, and starts to allow the application program read these configuration files so as to execute various software/hardware functions.

In summary, because the configuration files are sequentially generated and stored according to the file order table, the storage locations of the adjacent configuration files (previous and next configuration files) have a predetermined orderly correlation. Furthermore, the sanity check module 222 finds and sanity-checks the configuration files according to the file order table. Thus, the starting point for searching for a next adjacent configuration file is determined according to the location of the previously found configuration file and the properties of location correlation and sequence. For instance, the location of the previously found configuration file serves as the starting point for searching for the next adjacent configuration file. It is noted that the so-called adjacent configuration files mean that their filenames are located at adjacent fields in the file order table. Thus, the adjacent configuration files are sequentially generated and stored in the mobile phone when the mobile phone is manufactured, and the adjacent configuration files are sequentially searched and sanity-checked after the mobile phone is turned on.

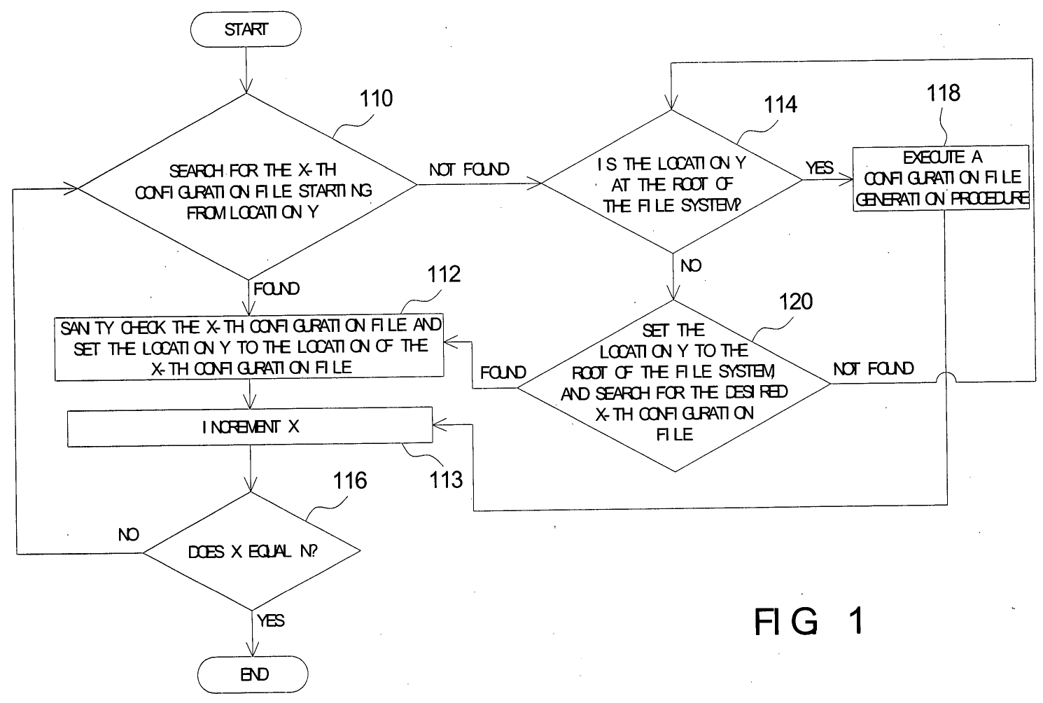

FIG. 1 is a flow chart showing a file search method of an electronic device according to a preferred embodiment of the invention.

After the mobile phone 200 is turned on, the sanity check module 222 executes the sanity check method. Assume that the mobile phone 200 has N configuration files. In step 110, the sanity check module 222 searches for the X-th configuration file according to the corresponding filename of the X-th field of the file order table, starting from the location Y. Initially, X is set to be 0 and the location Y is set to the root of the file system. If the file is found, step 112 is performed. If the file is not found, step 114 is executed.

In step 112, the sanity check module 222 sanity checks the X-th configuration and sets the location Y to the location of the X-th configuration file. Then, in step 113, the sanity check module 222 increments X, for example, by one. Next, in step 116, the sanity check module 222 determines whether X equals N. If so, the method is ended. If not, the method proceeds to step 110.

In step 114, the sanity check module 222 determines whether the location Y is at the root of the file system. If so, step 118 is performed. If not, step 120 is performed.

If the sanity check module 222 in step 114 determines that the location Y is at the root of the file system, it is indicated that even through the sanity check module 222 has searched all the configuration files in the file system for the X-th configuration file, the desired X-th configuration file is not found yet. In other words, the desired X-th configuration file never exists in the file system. Hence, in step 118, the sanity check module 222 executes a configuration file generation procedure so as to generate the desired X-th configuration file. Next, the sanity check module 222 executes step 113.

If the sanity check module 222, in step 114, determines that the location Y is not at the root of the file system, meaning that the sanity check module 222 has not searched all the configuration files in the file system for the X-th configuration file, in step 120, the sanity check module 222 will set the location Y to the root of the file system and start to search for the desired configuration file. If the file is found, step 112 is performed. If not, step 114 is executed.

In the executing of the sanity check method, if the location Y is set to the location of the previously found configuration file, and in the step 110, the next desired configuration file is not found, meaning that the location of the next desired configuration file is changed and has no location correlation with the location of the previously found configuration file, the location of the previously found configuration file would be no longer useful for searching for the next desired configuration file. At this time, the sanity check module 222 sets the location Y to the root of the file system so as to search all the configuration files in the file system for the desired configuration file.

As mentioned above, the file system generates and stores the configuration files according to the file order table, so that the locations of the configuration files have a predetermined sequence. In addition, the file system searches for the configuration files according to the file order table, where the location of the previously found configuration file serves as the start location for searching for a next adjacent configuration file. In general, the next adjacent configuration file may be successfully found and the time for searching the configuration files may be greatly shortened because the sanity check module 222 does not have to search from the beginning of the file system.

However, if the location Y is set to the location of the previously found configuration file and a next desired configuration file is not found after step 110 is executed, it indicates that the location of the next desired configuration file has been changed and has no correlation with the location of the previously found configuration file. Thus, the location of the previously found configuration file is no longer useful for searching for the next desired configuration file. In other words, the previous configuration file has no location correlation with the next configuration file. If such situation occurs frequently, it means that the location correlation of the configuration files is relatively small. At this time, it is necessary to reorder the configuration files. It is noted that the term “reorder” means moving the configuration files and changing the storage locations of the configuration files, such that a location correlation between the storage locations of the configuration files is formed.

The mobile phone 200 further includes a reordering module 224 and a control module 226 stored in the memory device. 220. The control module 226 includes a counter 228 having a count value C equal to 0 initially. Each time when the location Y is set to the location of the previously found configuration file and the next desired configuration file is not found after step 110 is executed, which is hereinafter referred to as the “search error”, the count value C is increased by 1. When the count value C is greater than a specific value, such as 5, the control module 226 enables the reordering module 224 to start to reorder the configuration files after the mobile phone 200 completely boots up.

In addition, the control module 226 may be implemented to have a first counter (not shown) and a second counter (not shown). The first count is for recording the number of search times of the sanity check module 222, and the second counter is for recording the number of search error times of the sanity check module 222. When the search errors frequently occur (e.g., three search errors occur in five searches), the control module 226 enables the reordering module 224 to start to reorder the configuration files after the mobile phone 200 completely boots up.

Moreover, the control module 226 may be designed to enable the reordering module 224 to start to reorder the configuration files after the mobile phone 200 completely boots up when the search errors successively occur a specific number of times.

Furthermore, the control module 226 may be designed to move the configuration file according to the sequence of the filenames of the configuration files in the file order table after the configuration file having the found search error when the sanity check module 222 has the search error. In this way, a location correlation between the locations of the configuration file and the previous adjacent configuration file is formed. However, the time required to boot the mobile phone 200 is increased. Thus, in one embodiment, preferably, the reordering module 224 reorders the configuration files after the mobile phone 200 boots up completely. In the case when a search error occurs in searching for the configuration file and the configuration file is then still not found, as mentioned above, the sanity check module 222 generates the desired configuration file. At this time, the sanity check module 222 generates the desired configuration file at a specific location such that a location correlation between the locations of the configuration file and the previous adjacent configuration file is formed.

The method for the reordering module 224 to reorder the configuration files will be described in the following. When the search error occurs, the control module 226 records the actual location of the configuration module having the search error in a location recording table. It is noted that the control module 226 records the actual location of the found configuration module when the search error occurs in searching for the configuration file. In the case of failure to find the configuration file with which a search error occurs, the control module 226 records the actual location of the newly generated configuration module. After the mobile phone 200 completely boots up, the reordering module, according to the location recording table, searches for the configuration file with which a search error occurs, and moves the configuration file with which the search error occurs, according to the location file order table, from the actual location to a specific location such that a location correlation between the locations of the reordered configuration file and its adjacent configuration file is formed. As a result, the mobile phone 200 can boot up faster in the subsequent booting because the search error can be prevented or the number of search errors is reduced.

The above embodiment of the invention has at least the following advantages over the conventional one.

Particularly, in the method of the present invention, the configurations files have a constant relative location and a certain locality property. In a preferred situation, meaning that configurations files to be searched are all existed, while searching the configurations files, the method of the invention would have a complexity O(N), wherein N corresponds to the number of search times. For instance, the search time for 120 configuration files is only about 0.23 seconds in the mobile phone according to the embodiment.

In contrast, the conventional file search method requires a longer search time, and any person skilled in the art would understand that it will have a greater complexity O(N²) since every search for the configuration files always starts from a certain root portion of the file system. Thus, the search speed is slow while being sanity checked with the conventional file search method to search for each configuration file. The conventional file search method is restricted in the FAT file system, and the control structure of each file and the actual contents of other files are simultaneously and randomly distributed over the data area in the FAT file system. Therefore, an effective search for each file requires each search procedure to be performed from a fixed root location, e.g. the beginning of the file system. Thus, when the mobile phone is executing the above-mentioned sanity check and if the number of the configuration files is about 120 as in the above-mentioned embodiment, the mobile phone spends 2.18 seconds to search the configuration files. Thus, the user may feel inconvenient and have bad evaluation on the mobile phone.

As above discussed, the complexity of the file search method of the invention in the preferred situation is O(N), but the complexity of the conventional method could only be O(N²). In particular, the file search method of the invention significantly outperforms the conventional one when the number of files is greater than 100. As mentioned in the above experiment of about 120 configuration files, the search time of the search method of the invention is only 0.23 seconds, while that of the conventional method is 2.18 seconds. That is, the search speed of the invention in a preferred situation is 900% faster than that of the conventional one.

The electronic device and its file search method according to the embodiments of the invention can speed up the sanity check for the configuration files and shorten the user's waiting time after the portable electronic device is turned on.

While the invention has been described by way of examples of the FAT file system and the mobile phone and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A file search method of an electronic apparatus, for searching for N configuration files stored in the electronic apparatus, the configuration files being in a file system of the electronic apparatus, N being a positive number, the file search method comprising:
(a) providing an X being initially equal to 0 and a location Y being initially at the root of the file system, X being an integer;
(b) searching for an X-th configuration file starting from the location Y;
(c) if the X-th configuration file is found, performing a sanity check on the X-th configuration file and setting the location Y to the location of the X-th configuration file;
(d) incrementing X; and
(e) determining whether X equals N; if so, ending the method; if not, proceeding to the step (b).

2. The file search method according to claim 1, wherein the N configuration files respectively correspond to N filenames, and the N filenames are respectively recorded in N fields of a file order table.

3. The file search method according to claim 2, wherein in the step (b), the method searches for the X-th configuration file according to the X-th field of the file order table having the corresponding filename.

4. The file search method according to claim 2, wherein if the X-th configuration file is not found in the step (b), the method further comprises the steps of:
(f) determining whether the location Y is at the root of the file system; if so, proceeding to step (g); otherwise, proceeding to step (h);
(g) performing a configuration file generation procedure to generate the X-th configuration file and proceeding to the step (d); and
(h) setting the location Y to the root of the file system and starting to search for the X-th configuration file; proceeding to the step (c) if the X-th configuration file is found; proceeding to the step (f) if not found.

5. The file search method according to claim 4, further comprising:
if the X-th configuration file is not found in the step (b), after the X-th configuration file is found in the step (h), moving the X-th configuration file according to the location of the filename corresponding to the X-th configuration file in the file order table, so that a location correlation between the X-th configuration file and the (X-1)th configuration file is formed.

6. The file search method according to claim 4, wherein in the step (g), the configuration file generation procedure, according to the location of the filename corresponding to the X-th configuration file in the file order table, generates the X-th configuration file at a location, so that a location correlation between the X-th configuration file and the (X-1)th configuration file is formed.

7. The file search method according to claim 2, further comprising:
incrementing a count value if the X-th configuration file is not found in the step (b); and
when the count value exceeds a specific value, after the electronic apparatus boots up, performing a configuration file reordering procedure.

8. The file search method according to claim 7, wherein the configuration file reordering procedure comprises:
if the X-th configuration file is not found in the step (b), after the X-th configuration file is found in the step (h), recording an actual location of the found X-th configuration file in a location recording table;
after the X-th configuration file is generated in the step (g), recording an actual location of the generated X-th configuration file in a location recording table; and
after the electronic apparatus boots up, searching for the configuration file according to the location recording table, and moving the configuration file from an actual location of the configuration file to a specific location, wherein a location correlation between the configuration file and another configuration file adjacent to the configuration file is formed.

9. The file search method according to claim 2, further comprising:
recording the number of times the step (b) performed in a first count value, and recording the number of times the step (b) fails to find the X-th configuration file in a second count value; and
if the ratio of the second count value to the first count value exceeds a specific value, performing a configuration file reordering procedure after the electronic apparatus boots up.

10. The file search method according to claim 9, wherein the configuration file reordering procedure comprises:
if the X-th configuration file is not found in the step (b), after the X-th configuration file is found in the step (h), recording an actual location of the found X-th configuration file in a location recording table;
after the X-th configuration file is generated in the step (g), recording an actual location of the generated X-th configuration file in a location recording table; and
after the electronic apparatus boots up, searching for the configuration file according to the location recording table, and moving the configuration file from an actual location of the configuration file to a specific location, so that a location correlation between the configuration file and another configuration file adjacent to the configuration file is formed.

11. The file search method according to claim 2, further comprising:
if the number of times the step (b) successively fails to find the X-th configuration file reaches a specific value, performing a configuration file reordering procedure after the electronic apparatus boots up.

12. The file search method according to claim 11, wherein the configuration file reordering procedure comprises:
if the X-th configuration file is not found in the step (b), after the X-th configuration file is found in the step (h), recording an actual location of the found X-th configuration file in a location recording table;
after the X-th configuration file is generated in the step (g), recording an actual location of the generated X-th configuration file in a location recording table; and
after the electronic apparatus boots up, searching for a configuration file of the configuration files according to the location recording table, and moving the configuration file from an actual location of the configuration file to a specific location, so that a location correlation between the configuration file and another configuration file adjacent to the configuration file is formed.

13. The file search method according to claim 1, wherein if the X-th configuration file is not found in the step (b), the method further comprises:
(f) determining whether the location Y is at the root of the file system; if so, proceeding to step (g); otherwise, proceeding to step (h);
(g) performing a configuration file generation procedure to generate the X-th configuration file and proceeding to the step (d); and
(h) setting the location Y to the root of the file system and searching for the X-th configuration file; proceeding to the step (c) if the X-th configuration file is found; proceeding to the step (f) if not found.

14. The file search method according to claim 13, further comprising:
if the X-th configuration file is not found in the step (b), after the X-th configuration file is found in the step (h), moving the X-th configuration file according to the location of the filename corresponding to the X-th configuration file in the file order table, so that a location correlation between the X-th configuration file and the (X-1)th configuration file is formed.

15. The file search method according to claim 13, wherein in the step (g), the configuration file generation procedure, according to the location of the filename corresponding to the X-th configuration file in the file order table, generates the X-th configuration file at a location, so that a location correlation between the X-th configuration file and the (X-1)th configuration file is formed.

16. The file search method according to claim 1, wherein the electronic apparatus is a mobile phone.

17. An electronic apparatus, comprising:
a memory device, storing a sanity check module and N configuration files, where N is a positive integer; and
a processor, coupled to the memory device, for executing the sanity check module to perform a sanity check on the N configuration files, the sanity check module performs the steps of:
(a) providing an X being initially equal to 0 and a location Y being initially at the root of the file system, X being an integer;
(b) searching for an X-th configuration file starting from the location Y;
(c) if the X-th configuration file is found, performing a sanity check on the X-th configuration file and setting the location Y to a location of the X-th configuration file;
(d) incrementing X; and
(e) determining whether X equals N; if so, ending the sanity check; if not, proceeding to the step (b).

18. The electronic apparatus according to claim 17, further comprising a file order table, wherein the N configuration files respectively correspond to N filenames, and the N filenames respectively are recorded in N fields of the file order table.

19. The electronic apparatus according to claim 18, wherein the step (b), the sanity search module, according to the X-th field of the file order table, searches for the X-th configuration file, which corresponds to the filename in the X-th field.

20. The electronic apparatus according to claim 18, wherein when the X-th configuration file is not found in the step (b), the sanity check module further performs the steps of:
(f) determining whether the location Y is at the root of the file system; if so, proceeding to the step (g); otherwise, proceeding to the step (h);
(g) performing a configuration file generation procedure to generate the X-th configuration file and proceeding to the step (d); and
(h) setting the location Y to the root of the file system and searching for the X-th configuration file; proceeding to the step (c) if the X-th configuration file is found; proceeding to the step (f) if not found.

21. The electronic apparatus according to claim 20, wherein the memory device further stores a control module;
wherein if the X-th configuration file is not found in the step (b), after the X-th configuration file is found in the step (h), the control module moves the X-th configuration file according to the location of the filename corresponding to the X-th configuration file in the file order table, so that a location correlation between the X-th configuration file and the (X-1)th configuration file is formed.

22. The electronic apparatus according to claim 20, wherein in the step (g), the configuration file generation procedure, according to the location of the filename corresponding to the X-th configuration file in the file order table, generates the X-th configuration file at a location, so that a location correlation between the X-th configuration file and the (X-1)th configuration file is formed.

23. The electronic apparatus according to claim 18, wherein the memory device further stores a reordering module and a control module; the control module comprises a counter;
when the sanity check module fails to find the X-th configuration file in the step (b), incrementing a count value of the counter; and
when the count value exceeds a specific value, the control module enables the reordering module to perform a configuration file reordering procedure after the electronic apparatus boots up.

24. The electronic apparatus according to claim 23, wherein the configuration file reordering procedure comprises:
when the X-th configuration file is not found in the step (b), after the X-th configuration file is found in the step (h), recording an actual location of the found X-th configuration file in a location recording table;
after the X-th configuration file is generated in the step (g), recording an actual location of the generated X-th configuration file in a location recording table; and
after the electronic apparatus boots up, searching for the configuration file according to the location recording table, and moving the configuration file from an actual location of the configuration file to a specific location, so that a location correlation between the configuration file and another configuration file adjacent to the configuration file is formed.

25. The electronic apparatus according to claim 18, wherein:
the memory device further stores a reordering module and a control module; the control module comprises a first counter and a second counter;
the number of times the step (b) performed is stored in the first counter, and the number of times that the step (b) fails to find the X-th configuration file is stored in the second counter; and
when the ratio of the value of the second counter to the value of the first counter exceeds a specific value, the control module enables the reordering module to perform a configuration file reordering procedure after the electronic apparatus boots up.

26. The electronic apparatus according to claim 25, wherein the configuration file reordering procedure comprises:
when the X-th configuration file is not found in the step (b), after the X-th configuration file is found in the step (h), recording an actual location of the found X-th configuration file in a location recording table;
after the X-th configuration file is generated in the step (g), recording an actual location of the generated X-th configuration file in a location recording table; and
after the electronic apparatus boots up, searching for the configuration file according to the location recording table, and moving the configuration file from an actual location of the configuration file to a specific location such that a location correlation between the configuration file and another configuration file adjacent to the configuration file is formed.

27. The electronic apparatus according to claim 18, wherein:
the memory device further stores a reordering module and a control module; the control module comprises a first counter and a second counter;
if the number of times that the sanity check module successively fails to find the X-th configuration file in performing the step (b) reaches a specific value, the control module enables the reordering module to perform a configuration file reordering procedure after the electronic apparatus boots up.

28. The electronic apparatus according to claim 27, wherein the configuration file reordering procedure comprises:
when the X-th configuration file is not found in the step (b), after the X-th configuration file is found in the step (h), recording an actual location of the found X-th configuration file in a location recording table;
after the X-th configuration file is generated in the step (g), recording an actual location of the generated X-th configuration file in a location recording table; and
after the electronic apparatus boots up, searching for the configuration file according to the location recording table, and moving the configuration file from an actual location of the configuration file to a specific location such that a location correlation between the configuration file and another configuration file adjacent to the configuration file is formed.

29. The electronic apparatus according to claim 17, wherein when the X-th configuration file is not found in the step (b), the sanity check module further performs the steps of:
(f) determining whether the location Y is at the root of the file system; if so, proceeding to the step (g); otherwise, proceeding to the step (h);
(g) performing a configuration file generation procedure to generate the X-th configuration file and proceeding to the step (d); and
(h) setting the location Y to the root of the file system and searching for the X-th configuration file; proceeding to the step (c) if the X-th configuration file is found; proceeding to the step (f) if not found.

30. The electronic apparatus according to claim 29, wherein the memory device further stores a control module;
wherein if the X-th configuration file is not found in the step (b), after the X-th configuration file is found in the step (h), the control module moves the X-th configuration file according to the location of the filename corresponding to the X-th configuration file in the file order table so that a location correlation between the X-th configuration file and the (X-1)th configuration file is formed.

31. The electronic apparatus according to claim 29, wherein in the step (g), the configuration file generation procedure, according to the location of the filename corresponding to the X-th configuration file in the file order table, generates the X-th configuration file at a location so that a location correlation between the X-th configuration file and the (X-1)th configuration file is formed.

32. The electronic apparatus according to claim 17, wherein the electronic apparatus is a mobile phone.

33. A file search method of an electronic apparatus, for searching for a plurality of configuration files stored in the electronic apparatus, the configuration files being in a file system of the electronic apparatus, the file search method comprising:
(a) searching for a first configuration file; if the first configuration file is found, proceeding to step (b); if not found, proceeding to step (c);
(b) searching for a second configuration file according to a location of the first configuration file in the electronic apparatus; and
(c) starting to searching for the first configuration file from the a specific location of the file system.

34. The file search file method according to claim 33, wherein in the step (b), the method searches for the second configuration file starting from the location of the first configuration file in the electronic apparatus.

35. The file search file method according to claim 33, wherein in the step (c), the specific location is at the root of the file system.

36. The file search file method according to claim 33, wherein in the step (c), if the first configuration file is found, the method proceeds to the step (b); if not found, the method performs a configuration file generation procedure to generate the first configuration file.

37. The file search file method according to claim 33, wherein the electronic apparatus is a mobile phone.

38. An electronic apparatus, comprising:
a memory device, storing a sanity check module and a plurality of configuration files, the configuration files being in a file system of the electronic apparatus; and
a processor, coupled to the memory device, for executing the sanity check module to perform a sanity check on the N configuration files, the sanity check module performs the steps of:
(a) searching for a first configuration file; proceeding to step (b) if the first configuration file is found; proceeding to step (c) if not found;
(b) searching for a second configuration file according to a location of the first configuration file in the electronic apparatus; and
(c) searching for the first configuration file from a specific location of the file system.

39. The electronic apparatus according to claim 38, wherein in the step (b), the sanity check module searches for the second configuration file starting from the location of the first configuration file in the electronic apparatus.

40. The electronic apparatus according to claim 38, wherein in the step (c), the specific location is the root of the file system.

41. The electronic apparatus according to claim 38, wherein in the step (c), if the first configuration file is found, the step (b) is performed; if not found, a configuration file generation procedure is performed to generate the first configuration file.

42. The electronic apparatus according to claim 38, wherein the electronic apparatus is a mobile phone.
